(19) United States
(12) Patent Application Publication
(10) Pub. No.: US 2001/0001646 A1
(43) Pub. Date: May 24, 2001

(54) METHOD OF PREPARING A CATALYTIC DEVICE AND AFTER-TREATING APPARATUS OF EXHAUST GAS USING THE CATALYTIC DEVICE

(76) Inventor: MOON-CHAN KIM, CHUNGCHEONGBUK-DO (KR)

Correspondence Address: JACOBSON, PRICE, HOLMAN & STERN, PLLC, The Jenifer Building, 400 Seventh Street, NW, Washington, DC, 20004-2201, US

(21) Appl. No.: 09/348,563

(22) Filed: Jul. 7, 1999

(30) Foreign Application Priority Data
Jul. 7, 1998 (KR) 27204

(51) Int. Cl. F01N 3/28; B01D 53/94

(52) U.S. Cl. 422/174; 422/171; 422/180

(57) ABSTRACT

An after-treating apparatus of exhaust gas and a catalyst device installed therein is disclosed. The after-treating apparatus of exhaust gas primarily removes the exhaust gas in a first filtering device and a second filtering device, and secondarily purifies within the catalyst device. The first filtering device and the second filtering device are controlled by opening and closing a valve through a time control part. That is, when particulate of the exhaust gas is collected in the first filtering device, the second filtering device burns the collected particulate by means of an electric heater. Also, the catalyst device is prepared by wash-coating an active substrate on a honeycomb, the active substrate being produced by supporting platinum, nickel, and promoter on a supporter of alumina and chromic oxide.

### BACKGROUND OF THE INVENTION

1. Field of the Invention

This invention relates to an after-treating apparatus of exhaust gas, and more particularly to an after-treating apparatus which firstly burns particulate of the exhaust gas collected in a ceramic filter, and secondly oxidizes CO into CO₂, HC into CO₂ and H₂O, and reduces NOx into N₂ by a catalytic device installed in the apparatus.

2. Prior Art

Generally, a method of and an apparatus for burning particulate collected by only a filter through heat wires or burner has been used. This is the method of mounting pressure sensors on a front side and a rear side of the filter, heating through the burner when the applied pressure is above the predetermined pressure, supplying air through a blower, and burning the particulate deposited in the filter.

However, the method shortens the life of the filter by rapidly raising the temperature due to burning the particulate or hydrocarbon in a short time. Also, smoke of exhaust gas can be removed to some degree, but the particulate is hard to remove above 80% thereof only through the ceramic filter because above 90% of the particulate are small particles having 1 μm and less size. HC, CO, and NOx are seldom removed, but rather it may happen that they are increased by back pressure of the ceramic filter.

Meanwhile, the methods of wash-coating a catalyst in the prior ceramic filter are under consideration to solve these problems. However, these methods have drawbacks that the temperature rises during regeneration of the ceramic filter, a crack occurs in the ceramic filter due to a difference of a coefficient of thermal expansion between the ceramic filter and metallic oxides coated thereon, and life of the ceramic filter is greatly shortened. Further, because of the temperature rise, the coated catalyst generates a sintering phenomenon above 700° C., and activity of the catalyst abruptly deteriorates. Also, in the filtering operation of the exhaust gas, a fouling phenomenon in which the smoke of the exhaust gas covers the catalyst is generated, so the exhaust gas is not treated efficiently.

Furthermore, in a prior catalyst containing noble metals, one makes an effort to coat fire-resistant inorganic oxides such as active alumina (Al₂O₃) with the noble metals in a higher dispersion.

However, the catalyst coating the noble metals in the higher dispersion has drawbacks that the initial activity is high, but under strict conditions such as high temperature and oxidization atmosphere, particles of the noble metals grow, a supporter is apt to react with the noble metals and promoter metals, and thus durability of the activity deteriorates.

A method of supporting noble metals on a supporter containing alumina and zirconia in order to acquire a catalyst having a good heat-resistance and a stable special property is disclosed in Japanese Patent Nos. S57-29215(B2) and S57-153737 (A). However, in the above method, because the noble metals are substantially high-dispersed on the alumina, activity is reduced.

Further, methods of using zirconia or α-alumina as a supporter not reacting with noble metals in high temperature and oxidization atmosphere are disclosed in U.S. Pat. Nos. 4,233,189 and 4,172,047, respectively.

### THE SUMMARY OF THE INVENTION

To solve the above problems, it is a first object of the present invention to provide a catalyst device which has a good durability under strict conditions and high purifying capacity for harmful components of exhaust gas at low temperature, and a method of preparing the same.

It is a second object of the present invention to provide an after-treating apparatus of exhaust gas which has at least two filtering devices and a catalyst device in order to substantially increase purifying capacity of the exhaust gas without applying high load to an engine.

To obtain these objects, the catalyst device according to the present invention includes a honeycomb; a supporter coated on the honeycomb, the supporter consisting of a mixture of γ-Al₂O₃ and Cr₂O₃; and a catalyst supported on the supporter, the catalyst containing platinum and nickel with at least one promoter metal selected from Sn, Fe, Mn, Cu, V, Zn, Ba, Ag, and Au.

Further, a method for preparing the catalyst device according to the present invention comprises the steps of mixing γ-Al₂O₃ and Cr₂O₃, wet-pulverizing the mixture through a ball mill, and producing a supporter of water slurry; dipping a honeycomb having a plurality of cells in the supporter; drawing out the honeycomb, and blowing the extra slurry in the cells through compressed air; drying the blown honeycomb; dipping the dried honeycomb in a mixing solution consisting of aqueous platinum chloride solution containing platinum, aqueous nickel chloride solution containing nickel, and catalytic composite containing at least one element selected from Sn, Fe, Mn, Cu, V, Zn, Ba, Ag, and Au; and drying and calcining the honeycomb.

An after-treating apparatus of exhaust gas using the catalyst device according to the present invention comprises a main pipe connected to an engine; a first duct extended from the main pipe into one side and having a first inlet port for inflow of the exhaust gas; a second duct extended from the main pipe into the other side and having a second inlet port for inflow of the exhaust gas; a first filtering device integrally formed in a center portion of the first duct, the first filtering device having a first ceramic filter inside and a first electric heater mounted on one end of the first ceramic filter facing the engine; a second filtering device integrally formed in a center portion of the second duct, the second filtering device having a second ceramic filter inside and a second electric heater mounted on one end of the second ceramic filter facing the engine; a valve for selectively opening and closing the first inlet port and the second inlet port; a time control part for operating the valve in a predetermined time and simultaneously applying electric power on the electric heater selected from the first electric heater and the second electric heater for a predetermined time; and a catalytic converter having a housing connected to the first duct and the second duct, and a catalyst device received in the housing.

### BRIEF DESCRIPTION OF THE DRAWINGS

This invention will be better understood and its various objects and advantages will be more fully appreciated from the following description taken in conjunction with the accompanying drawings, in which:

FIG. 1 is a schematic view showing an after-treating apparatus of exhaust gas according to a preferred embodiment of the present invention,

FIG. 2 is a perspective view showing an electric heater of the after-treating apparatus of the exhaust gas according to the present invention,

FIG. 3 is an enlarged sectional view of a catalyst device according to the present invention, and

FIG. 4 is a flow chart showing a method of preparing the catalyst device according to the present invention.

### DETAILED DESCRIPTION OF THE PREFERRED EMBODIMENT

Hereinafter, preferred embodiments according to the present invention will be described in detail with reference to the drawings.

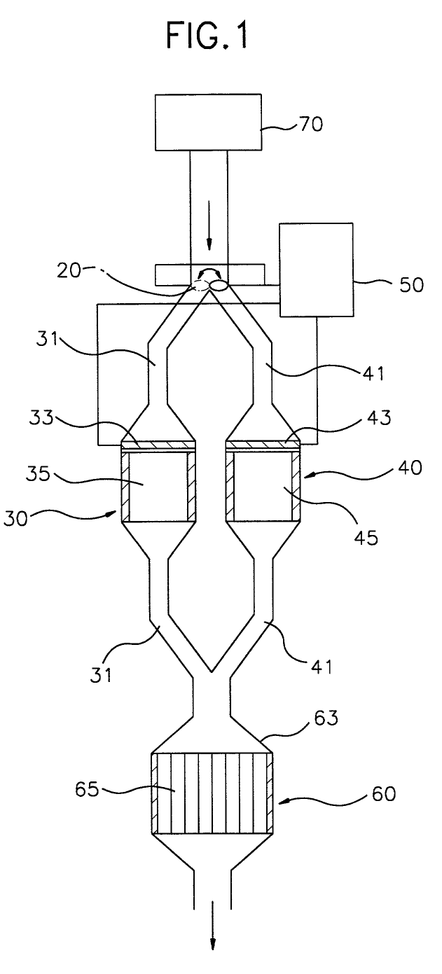

FIG. 1 is a schematic view showing an after-treating apparatus of exhaust gas according to a preferred embodiment of the present invention. In the drawings a hood side having an engine 70 is located in a front portion, and a trunk side is located in a rear portion with reference to a vehicle body.

As shown in FIG. 1, the after-treating apparatus of the exhaust gas includes a main pipe 10 connected to the engine 70, a first and a second filtering devices 30,40 as a primary filtering means, and a catalytic converter 60 as a secondary filtering means.

For inflow of the exhaust gas from the engine 70, a first duct 31 extended from the main pipe 10 into one side of the vehicle's rear portion has a first inlet port 25, and a second duct 41 extended from the main pipe 10 into the other side of the vehicle's rear portion has a second inlet port 27. Also, a valve 20 is installed between the main pipe 10 and the first and the second inlet ports 25,27 in order to selectively open and close the first inlet port 25 and the second inlet port 27.

The first filtering device 30 is integrally mounted in a center portion of the first duct 31. A first ceramic filter 35 for filtering particulate of the exhaust gas and a first electric heater 33 for burning the particulate collected in the first ceramic filter 35 are installed in the first filtering device 30. A filter material of 7.5 in.—outer diameter and 8 in.—length is used as a material of the first ceramic filter 35. The first electric heater 33 is installed adjacent to the first ceramic filter 35 between the first duct 31 and the first ceramic filter 35.

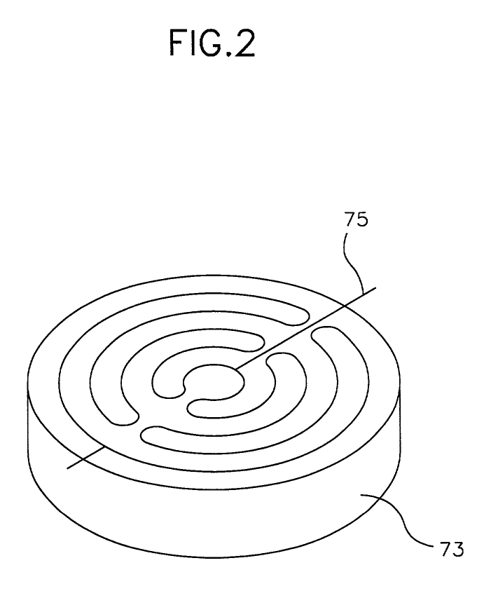

FIG. 2 is a perspective view showing an electric heater of the after-treating apparatus of the exhaust gas according to the present invention.

As shown in FIG. 2, the first electric heater 33 includes a base 73 and a heating wire 75, and is supplied with an electric power from a 12V-battery or a 24V-battery for starting the engine. Also, nichrome wire or metal composite wire is used originally and by ceramic-coating as the heating wire 75. The base 73 is made from ceramic plate or mica plate.

The second filtering device 40 has a second duct 41, a second electric heater 43, and a second ceramic filter 45, which is the same with the structure of the first filtering device 30, and is installed parallel to the first filtering device 30. Accordingly, description for the constituting elements of the second filtering device 40 will be omitted.

The first and the second filtering device 30,40 communicates with a housing 63 of the catalytic converter 60 by the first duct 31 and the second duct 41. Also, a catalyst device 65 is received in the housing 63 in order to remove gaseous substances and hydrocarbon of the exhaust gas flowing into the housing 63 again. The catalyst device 65 is formed of a honeycomb structure or a pellet structure, and preferably is formed of a honeycomb structure.

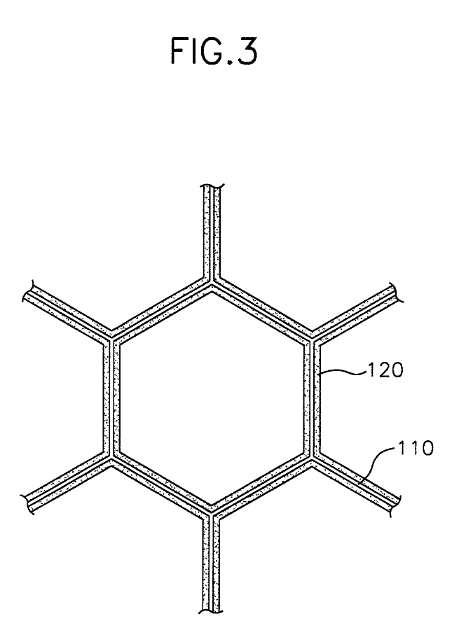

FIG. 3 is an enlarged sectional view of a catalyst device according to the present invention.

As shown in FIG. 3, the catalyst device 65 comprises a honeycomb, a supporter coated on the honeycomb and consisting of a mixture of alumina(γ-Al₂O₃) and chromic oxide(Cr₂O₃), and a catalyst containing platinum and nickel and at least one promoter metal selected from Sn, Fe, Mn, Cu, V, Zn, Ba, Ag, and Au.

Furthermore, a time control part 50 for controlling an opening and closing time of the valve 20 and an operating time of the first electric heater and the second electric heater is installed at a predetermined position. The time control part 50 has a timer (not shown) inside for constantly maintaining the total operating time of the valve by memorizing the operating time in spite of non-operating state of the engine.

Hereinafter, an operation of the after-treating apparatus of the exhaust gas according to the present invention will be described.

When the valve 20 opens the first inlet port 25 and closes the second inlet port 27, the exhaust gas emitted from the engine 70 is collected in the first ceramic filter 35 via the first duct 31, in which the particulate of the exhaust gas is substantially collected. At this time, the collecting time of the exhaust gas, that is, the operating time of the valve 20 is controlled by the time control part 50, is preferably 100≈120 minutes, and more preferably 120 minutes. When the operating time of the valve 20 exceeds 120 minutes, adhesion of hydrocarbon and particulate increases and back pressure of the filtering device becomes high, thereby applying a great load to the engine. When the operating time of the valve 20 is smaller than 120 minutes, consumption of the electric power increases. At the same time, in the second filtering device 40, electric power is applied to the second heater 43 and thus the particulate collected in the second ceramic filter 45 is burned, in which the burning time is controlled by the time control part 50, and preferably is approximately 20 minutes. When the burning time exceeds 20 minutes, the second ceramic filter 45 is damaged by heat. When the burning time is smaller than 20 minutes, the second electric heater 45 does not perfectly burn the collected particulate, thereby increasing back pressure of the second ceramic filter.

Meanwhile, when the opening time of the first inlet port 25 reaches 120 minutes, the valve 20 closes the first inlet port 25 and opens the second inlet port 27 by control of the time control part 50. Accordingly, as mentioned above, the exhaust gas emitted from the engine 70 is collected in the second ceramic filter 45 via the second duct 41 for 120 minutes, and the particulate previously collected in the first ceramic filter 35 is burned by the first electric heater 33 for 20 minutes.

The above operation is continuously repeated during operation of the engine. Even though the engine does not operate, the continuous timer of the time control part 50 memorizes the collecting time of the exhaust gas, and thereby constantly maintains the operating time of the valve 20 in a re-operating state of the engine.

The exhaust gas primarily filtered by the first filtering device 30 and the second filtering device 40 flowing into the housing 63 of the catalytic converter 60. The exhaust gas flowed in the housing 63 substantially includes harmful gaseous substances, such as HC, CO, NOx. The harmful gaseous substances pass through the catalyst device 65 in the housing 63, and are purified by generating oxidation and reduction with platinum, nickel, and promoter metal coated on the catalyst device 65.

As mentioned above, the after-treating apparatus of the exhaust gas firstly removes the particulate of the exhaust gas by the filtering devices 30,40 and secondly removes the gaseous substances and hydrocarbon by the catalyst device 65 of the catalytic converter 60, thereby increasing the purifying capacity of the exhaust gas.

Hereinafter, the catalyst device 65 and the preparing method of the same according to the present invention will be described.

The catalyst device 65 according to the present invention is prepared by wash-coating an active substrate on the honeycomb, in which the active substrate is formed by supporting platinum, nickel, and promoter metal on the supporter of alumina and chromic oxide.

A scope of weight ratio of alumina and chromic oxide is 99:1 to 1:99, and is prepared to easily coat on the honeycomb.

A source of platinum is preferably selected from a group consisting of Chloroplatinite, Dinitrodiamineplatinum, Platinum sulphate complex salt, and Platinum tetramine chloride and a source of nickel is preferably selected from Nickel nitrate and Nickel chloride.

Platinum and nickel have synergy effect reciprocally, and a ratio of platinum and nickel is preferably ┌nickel/(nickel+platinum)= 0.02≈0.2┘. When only one metal of platinum and nickel is used, the ratio of platinum and nickel is larger than 0.2 or the ratio is smaller than 0.02, so the oxidization conversion rate of HC and CO deteriorates.

Furthermore, platinum and nickel is supported on the mixture of alumina and chromic oxide by ratio of 0.05≈5 weight %. When the ratio is smaller than 0.05 weight %, it is difficult to have sufficient activity, and when the ration is larger than 5 weight %, particle growth between metal particles is accelerated, thereby deteriorating activity.

The promoter metal maintaining a strong activity oxidizes hydrocarbon and carbon monoxide and reduces nitrogen oxide. Also, the promoter metal is preferably contained by 0.1≈20 weight % about the supporter, and more preferably by 0.5≈10 weight %.

The honeycomb has a monolith structure, and is preferably made from a material selected from a group consisting of cordierite, mordenite, mullite, α-alumina, γ-alumina, aluminosilicate, spinel, and magnesium silicate. More preferably, the honeycomb used in a diesel vehicle is made from cordierite.

The active substrate is coated on honeycomb with a concentration of 10≈350g/dm³, and preferably a concentration of 30≈200g/dm³.

The above mentioned catalyst device may be used in a vehicle, ship, train, and internal combustion engine for industry.

Hereinafter, examples and comparative examples of the catalyst device and the preparing method of the same according to the present invention will be described.

The purifying capacity of the after-treating apparatus of exhaust gas in diesel vehicle is examined in examples 1≈11 and comparative examples 1≈11.

An engine of the diesel vehicle is a 4-stroke engine of straight-vertical type, and combustion type of the engine is a direct injection type. The specification of the engine is as follows:

(a) Six-cylinders in which the inner diameter of cylinder X stroke is 123mm×155mm,

(b) Stroke volume is 11,051 cc,

(c) Compression ratio is 17.1:1,

(d) Maximum torque/velocity of engine is 81.5 Kgm/1400 rpm, and

(e) Maximum output/velocity of engine is 780 Nm/2,200 rpm.

The catalyst device for the engine having the above specification uses for 100 hours under the condition that temperature of the after-treating apparatus of the exhaust gas is 450° C. in normal operating state. Also, an examiner examines a removable rate of total particulate matter(TPM), hydrocarbon (HC), volatile organic fraction(VOF), carbon monoxide(CO) and NOx in space velocity= about 300,000 hr⁻¹, and a 50% oxidization conversion rate of new product and aged product in order to measure a purifying capacity in low temperature and a durability of oxidization conversion rate.

Table 1 indicates constituting components of the honeycomb coating the catalyst, and Table 2 indicates a performance of the after-treating apparatus of the exhaust gas.

### EXAMPLE 1

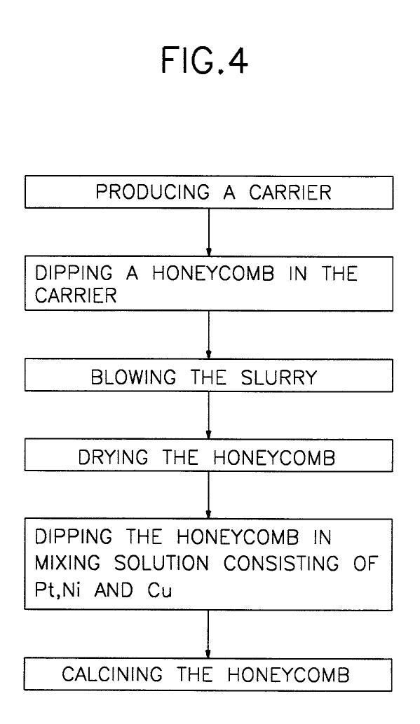

FIG. 4 is a flow chart showing a method of preparing the catalyst device according to the present invention. As shown in FIG. 4, a catalyst device according to the present invention is prepared by

(a) mixing 400 g-alumina(γ-A1₂O₃) having specific surface of 210 m²/g and 40 g-chromic oxide (Cr₂O₃), wet-pulverizing the mixture through a ball mill for 20 hours, and producing a supporter of aqueous slurry,

(b) dipping the four monolith honeycomb on the supporter, the honeycomb having a plurality of gas communicating cells formed of about 400 cells/in² and being made from cordierite of 5.66 in.-outer diameter and 6 in.-length,

(c) drawing out the dipped honeycomb, blowing extra slurry in the cells by compressed air, and drying the honeycomb in 120° C. for 12 hours,

(d) dipping the dried honeycomb in a mixed aqueous solution consisting of platinum chloride containing 4.0 g-platinum, nickel chloride containing 0.4 g-nickel, and copper chloride containing 0.4 g-copper, and

(e) drying the honeycomb in 120° C. for 12 hours, and calcining in 600° C. for 2 hours.

Accordingly, the catalyst device is prepared by coating an active substrate on the honeycomb, the active substrate being formed by supporting platinum, nickel, and copper on the supporter consisting of alumina and chromic oxide.

A performance of the after-treating apparatus of the exhaust gas using the catalyst device is listed on Table 2.

### EXAMPLE 2

A catalyst device and a preparing method of the same according to Example 2 is the same as that of Example 1 except that the (E) component of Table 1 is 0.4 g-Ag. A performance of the after-treating apparatus of the exhaust gas using the catalyst device is listed on Table 2.

### EXAMPLE 3

A catalyst device and a preparing method of the same according to Example 3 is the same as that of Example 1 except that the (E) component of Table 1 is 0.4 g-Sn. A performance of the after-treating apparatus of the exhaust gas using the catalyst device is listed on Table 2.

### EXAMPLE 4

A catalyst device and a preparing method of the same according to Example 4 is the same as that of Example 1 except that the (E) component of Table 1 is 0.4 g-Fe. A performance of the after-treating apparatus of the exhaust gas using the catalyst device is listed on Table 2.

### EXAMPLE 5

A catalyst device and a preparing method of the same according to Example 5 is the same as that of Example 1 except that the (E) component of Table 1 is 0.4 g-Mn. A performance of the after-treating apparatus of the exhaust gas using the catalyst device is listed on Table 2.

### EXAMPLE 6

A catalyst device and a preparing method of the same according to Example 6 is the same as that of Example 1 except that the (E) component of Table 1 is 0.4 g-V. A performance of the after-treating apparatus of the exhaust gas using the catalyst device is listed on Table 2.

### EXAMPLE 7

A catalyst device and a preparing method of the same according to Example 7 is the same as that of Example 1 except that the (E) component of Table 1 is 0.4 g-Zn. A performance of the after-treating apparatus of the exhaust gas using the catalyst device is listed on Table 2.

### EXAMPLE 8

A catalyst device and a preparing method of the same according to Example 8 is the same as that of Example 1 except that the (E) component of Table 1 is 0.4 g-Ba. A performance of the after-treating apparatus of the exhaust gas using the catalyst device is listed on Table 2.

### EXAMPLE 9

A catalyst device and a preparing method of the same according to Example 9 is the same as that of Example 1 except that the (E) component of Table 1 is 0.4 g-Au. A performance of the after-treating apparatus of the exhaust gas using the catalyst device is listed on Table 2.

### EXAMPLE 10

A catalyst device and a preparing method of the same according to Example 10 is the same as that of Example 1 except that the (E) component of Table 1 is 0.4 g-Ag and 0.4 g-V. A performance of the after-treating apparatus of the exhaust gas using the catalyst device is listed on Table 2.

### EXAMPLE 11

A catalyst device and a preparing method of the same according to Example 11 is the same as that of Example 1 except that the (E) component of Table 1 is 0.4 g-Ag and 0.4 g-Cu. A performance of the after-treating apparatus of the exhaust gas using the catalyst device is listed on Table 2.

### COMPARATIVE EXAMPLE 1

A catalyst device and a preparing method of the same according to Comparative Example 1 is the same as that of Example 1 except that the (B) component of Table 1 is not contained. A performance of the after-treating apparatus of the exhaust gas using the catalyst device is listed on Table 2.

### COMPARATIVE EXAMPLE 2

A catalyst device and a preparing method of the same according to Comparative Example 2 is the same as that of Example 1 except that the (B) component of Table 1 contains 0.5 g. A performance of the after-treating apparatus of the exhaust gas using the catalyst device is listed on Table 2.

### COMPARATIVE EXAMPLE 3

A catalyst device and a preparing method of the same according to Comparative Example 3 is the same as that of Example 1 except that the (C) component of Table 1 is not contained. A performance of the after-treating apparatus of the exhaust gas using the catalyst device is listed on Table 2.

### COMPARATIVE EXAMPLE 4

A catalyst device and a preparing method of the same according to Comparative Example 4 is the same as that of Example 1 except that the (C) component of Table 1 contains 0.5 g. A performance of the after-treating apparatus of the exhaust gas using the catalyst device is listed on Table 2.

### COMPARATIVE EXAMPLE 5

A catalyst device and a preparing method of the same according to Comparative Example 5 is the same as that of Example 1 except that the (D) component of Table 1 is not contained. A performance of the after-treating apparatus of the exhaust gas using the catalyst device is listed on Table 2.

### COMPARATIVE EXAMPLE 6

A catalyst device and a preparing method of the same according to Comparative Example 6 is the same as that of Example 1 except that the (D) component of Table 1 contains 0.04 g. A performance of the after-treating apparatus of the exhaust gas using the catalyst device is listed on Table 2.

### COMPARATIVE EXAMPLE 7

A catalyst device and a preparing method of the same according to Comparative Example 7 is the same as that of Example 1 except that the (D) component of Table 1 contains 1.0 g. A performance of the after-treating apparatus of the exhaust gas using the catalyst device is listed on Table 2.

### COMPARATIVE EXAMPLE 8

A catalyst device and a preparing method of the same according to Comparative Example 8 is the same as that of Example 1 except that the (D) component of Table 1 contains 1.0 g and the (E) component of Table 1 is not contained. A performance of the after-treating apparatus of the exhaust gas using the catalyst device is listed on Table 2.

### COMPARATIVE EXAMPLE 9

A catalyst device and a preparing method of the same according to Comparative Example 9 is the same as that of Example 1 except that the (D) and (E) components of Table 1 are not contained. A performance of the after-treating apparatus of the exhaust gas using the catalyst device is listed on Table 2.

### COMPARATIVE EXAMPLE 10

An after-treating apparatus of exhaust gas which wash-coats the catalyst components of Example 1 on ceramic filters without using the catalyst device of Example 1 is used. A performance of the after-treating apparatus of the exhaust gas is listed on Table 2.

TABLE 1
Components of active substrate

| | (A) | (B) | (C) | (D) | (E) |
|---|---|---|---|---|---|
| EXAMPLE 1 | γ-Al₂O₃ | Cr₂O₃ | Pt | Ni | Cu |
| | 400 g | 40 g | 4 g | 0.4 g | 0.4 g |
| EXAMPLE 2 | γ-Al₂O₃ | Cr₂O₃ | Pt | Ni | Ag |
| | 400 g | 40 g | 4 g | 0.4 g | 0.4 g |
| EXAMPLE 3 | γ-Al₂O₃ | Cr₂O₃ | Pt | Ni | Sn |
| | 400 g | 40 g | 4 g | 0.4 g | 0.4 g |
| EXAMPLE 4 | γ-Al₂O₃ | Cr₂O₃ | Pt | Ni | Fe |
| | 400 g | 40 g | 4 g | 0.4 g | 0.4 g |
| EXAMPLE 5 | γ-Al₂O₃ | Cr₂O₃ | Pt | Ni | Mn |
| | 400 g | 40 g | 4 g | 0.4 g | 0.4 g |
| EXAMPLE 6 | γ-Al₂O₃ | Cr₂O₃ | Pt | Ni | V |
| | 400 g | 40 g | 4 g | 0.4 g | 0.4 g |
| EXAMPLE 7 | γ-Al₂O₃ | Cr₂O₃ | Pt | Ni | Zn |
| | 400 g | 40 g | 4 g | 0.4 g | 0.4 g |
| EXAMPLE 8 | γ-Al₂O₃ | Cr₂O₃ | Pt | Ni | Ba |
| | 400 g | 40 g | 4 g | 0.4 g | 0.4 g |
| EXAMPLE 9 | γ-Al₂O₃ | Cr₂O₃ | Pt | Ni | Au |
| | 400 g | 40 g | 4 g | 0.4 g | 0.4 g |
| EXAMPLE 10 | γ-Al₂O₃ | Cr₂O₃ | Pt | Ni | Ag 0.4 g |
| | 400 g | 40 g | 4 g | 0.4 g | V 0.4 g |
| EXAMPLE 11 | γ-Al₂O₃ | Cr₂O₃ | Pt | Ni | Ag 0.4 g |
| | 400 g | 40 g | 4 g | 0.4 g | Cu 0.4 g |
| COMPARATIVE | γ-Al₂O₃ | — | Pt | Ni | Cu |
| EXAMPLE 1 | 400 g | | 4 g | 0.4 g | 0.4 g |
| COMPARATIVE | γ-Al₂O₃ | Cr₂O₃ | Pt | Ni | Cu |
| EXAMPLE 2 | 400 g | 0.5 g | 4 g | 0.4 g | 0.4 g |
| COMPARATIVE | γ-Al₂O₃ | Cr₂O₃ | — | Ni | Cu |
| EXAMPLE 3 | 400 g | 40 g | — | 0.4 g | 0.4 g |
| COMPARATIVE | γ-Al₂O₃ | Cr₂O₃ | Pt | Ni | Cu |
| EXAMPLE 4 | 400 g | 40 g | 0.5 g | 0.4 g | 0.4 g |
| COMPARATIVE | γ-Al₂O₃ | Cr₂O₃ | Pt | — | Cu |
| EXAMPLE 5 | 400 g | 40 g | 4 g | — | 0.4 g |
| COMPARATIVE | γ-Al₂O₃ | Cr₂O₃ | Pt | Ni | Cu |
| EXAMPLE 6 | 400 g | 40 g | 4 g | 0.04 g | 0.4 g |
| COMPARATIVE | γ-Al₂O₃ | Cr₂O₃ | Pt | Ni | Cu |
| EXAMPLE 7 | 400 g | 40 g | 4 g | 1.0 g | 0.4 g |
| COMPARATIVE | γ-Al₂O₃ | Cr₂O₃ | Pt | Ni | — |
| EXAMPLE 8 | 400 g | 40 g | 4 g | 1.0 g | |
| COMPARATIVE | γ-Al₂O₃ | Cr₂O₃ | Pt | — | — |
| EXAMPLE 9 | 400 g | 40 g | 4 g | | |
| COMPARATIVE | γ-Al₂O₃ | Cr₂O₃ | Pt | Ni | Cu |
| EXAMPLE 10 | 400 g | 40 g | 4 g | 0.4 g | 0.4 g |

TABLE 2
A performance of after-treating apparatus of exhaust gas

| | | | | | | 50% CONVERSION | | | 50% CONVERSION | | |
|---|---|---|---|---|---|---|---|---|---|---|---|
| | | | | | | TEMPERATURE OF | | | TEMPERATURE OF | | |
| | REMOVABLE RATE (%) | | | | | NEW PRODUCT(° C.) | | | AGED PRODUCT(° C.) | | |
| | TPM | HC | VOF | CO | NOx | TPM | HC | CO | TPM | HC | CO |
| EXAMPLE 1 | 92 | 98 | 99 | 99 | 43 | 200 | 190 | 190 | 203 | 192 | 192 |
| EXAMPLE 2 | 93 | 99 | 99 | 99 | 44 | 199 | 189 | 190 | 202 | 191 | 192 |
| EXAMPLE 3 | 91 | 97 | 99 | 99 | 39 | 201 | 191 | 190 | 204 | 193 | 192 |
| EXAMPLE 4 | 92 | 98 | 99 | 99 | 43 | 200 | 190 | 190 | 203 | 192 | 192 |
| EXAMPLE 5 | 92 | 98 | 99 | 99 | 45 | 200 | 190 | 190 | 203 | 192 | 192 |
| EXAMPLE 6 | 91 | 97 | 99 | 99 | 45 | 201 | 191 | 190 | 204 | 193 | 192 |
| EXAMPLE 7 | 91 | 97 | 99 | 99 | 36 | 201 | 191 | 190 | 204 | 193 | 192 |
| EXAMPLE 8 | 90 | 96 | 98 | 99 | 38 | 202 | 192 | 190 | 205 | 194 | 192 |
| EXAMPLE 9 | 93 | 99 | 99 | 99 | 44 | 199 | 189 | 190 | 202 | 191 | 192 |
| EXAMPLE 10 | 93 | 99 | 99 | 99 | 45 | 199 | 189 | 190 | 202 | 191 | 192 |
| EXAMPLE 11 | 94 | 99 | 99 | 99 | 46 | 198 | 189 | 190 | 201 | 191 | 192 |
| COMPARATIVE | 90 | 97 | 99 | 99 | 9 | 202 | 191 | 190 | 205 | 194 | 192 |
| EXAMPLE 1 | | | | | | | | | | | |
| COMPARATIVE | 90 | 97 | 98 | 98 | 10 | 202 | 191 | 190 | 205 | 194 | 192 |
| EXAMPLE 2 | | | | | | | | | | | |
| COMPARATIVE | 72 | 73 | 85 | 85 | 13 | 245 | 238 | 231 | 248 | 241 | 234 |
| EXAMPLE 3 | | | | | | | | | | | |
| COMPARATIVE | 87 | 90 | 95 | 95 | 17 | 221 | 199 | 198 | 224 | 202 | 201 |
| EXAMPLE 4 | | | | | | | | | | | |
| COMPARATIVE | 89 | 94 | 97 | 96 | 15 | 215 | 195 | 194 | 218 | 198 | 197 |
| EXAMPLE 5 | | | | | | | | | | | |
| COMPARATIVE | 89 | 94 | 97 | 96 | 15 | 215 | 195 | 194 | 218 | 198 | 197 |
| EXAMPLE 6 | | | | | | | | | | | |
| COMPARATIVE | 90 | 97 | 98 | 98 | 27 | 202 | 191 | 191 | 194 | 195 | 194 |
| EXAMPLE 7 | | | | | | | | | | | |
| COMPARATIVE | 90 | 97 | 98 | 98 | 9 | 202 | 191 | 191 | 194 | 195 | 194 |
| EXAMPLE 8 | | | | | | | | | | | |
| COMPARATIVE | 78 | 80 | 88 | 88 | 2 | 237 | 229 | 226 | 240 | 231 | 229 |
| EXAMPLE 9 | | | | | | | | | | | |
| COMPARATIVE | 87 | 94 | 95 | 97 | 38 | 221 | 195 | 198 | 224 | 198 | 201 |
| EXAMPLE 10 | | | | | | | | | | | |

As indicated in Table 2 regarding the removable rate of harmful substances of the exhaust gas, the removable rate of Examples 1-11 is better than that of Comparative Examples 1-10, and particularly the removable rate of NOx is quite excellent. Further, referring to conversion temperature in which the removable rate of the harmful substances becomes 50%, the conversion temperature of Examples 1-11 is relatively lower than that of Comparative Examples 1-10. That is, the removable rate of the harmful substances of Example 1-11 is higher than that of Comparative Examples 1-10 at a low temperature state.

As mentioned above, the after-treating apparatus of the exhaust gas alternately uses the first filtering device and the second filtering device, thereby increasing durability of the filtering devices and purifying capacity. Also, the apparatus is installed with the catalytic converter having the catalyst device at the rear portion of the filtering devices separately, and thereby greatly reduces the harmful substances of the exhaust gas. Furthermore, the catalyst device according to the present invention has good durability under strict conditions such as high temperature and oxidization atmosphere, and high purifying capacity for the harmful substances at a low temperature state.

While this invention has been particularly shown and described with reference to particular embodiments thereof, it will be understood by those skilled in the art that various changes in form and detail may be effected therein without departing from the spirit and scope of the invention as defined by the appended claims.

What is claimed is:

1. A method of preparing a catalyst device comprising the steps of:
mixing γ-Al₂O₃ and Cr₂O₃, wet-pulverizing the mixture through a ball mill, and producing a supporter of water slurry;
dipping a honeycomb having a plurality of cells in the supporter;
drawing out the honeycomb, and blowing the extra slurry in the cells through compressed air;
drying the blown honeycomb;
dipping the dried honeycomb in a mixing solution consisting of aqueous platinum chloride solution containing platinum, aqueous nickel chloride solution containing nickel, and catalytic composite containing at least one element selected from Sn, Fe, Mn, Cu, V, Zn, Ba, Ag, and Au; and
drying and calcining the honeycomb.

2. A catalyst device comprising:
a honeycomb;
a supporter coated on the honeycomb, the supporter consisting of a mixture of γ-A1₂O₃ and Cr₂O₃; and
a catalyst supported on the supporter, the catalyst containing platinum and nickel with at least one promoter metal selected from Sn, Fe, Mn, Cu, V, Zn, Ba, Ag, and Au.

3. The catalyst device according to claim 2, wherein weight ratio of γ-Al₂O₃ : Cr₂O₃ includes 99:1 to 1:99.

4. The catalyst device according to claim 3, wherein the supporter includes 400 g γ-Al₂O₃ and 40 g Cr₂O₃.

5. The catalyst device according to claim 2, wherein the honeycomb is made from at least one material selected from cordierite, mordenite, mullite, α-alumina, γ-alumina, aluminosilicate, spinel, and magnesium silicate.

6. The catalyst device according to claim 2, wherein the supporter plus the catalyst has 10≈350 g/dm3 concentration to the honeycomb.

7. The catalyst device according to claim 2, wherein the platinum and the nickel have weight ratio of Ni/(Ni+Pt)=0.02≈0.2.

8. The catalyst device according to claim 2, wherein the platinum and the nickel is supported on the supporter by ratio of 0.05≈5 weight %.

9. The catalyst device according to claim 2, wherein the supporter includes 0.1≈20 weight % promoter metal.

10. An after-treating apparatus of exhaust gas comprising:
a main pipe connected to an engine;
a first duct extended from the main pipe into one side and having a first inlet port for inflow of the exhaust gas;
a second duct extended from the main pipe into the other side and having a second inlet port for inflow of the exhaust gas;
a first filtering device integrally formed in a center portion of the first duct, the first filtering device having a first ceramic filter inside and a first electric heater mounted on one end of the first ceramic filter facing the engine;
a second filtering device integrally formed in a center portion of the second duct, the second filtering device having a second ceramic filter inside and a second electric heater mounted on one end of the second ceramic filter facing the engine;
a valve for selectively opening and closing the first inlet port and the second inlet port;
a time control part for operating the valve in a predetermined time and simultaneously applying electric power on the electric heater selected from the first electric heater and the second electric heater for a predetermined time; and
a catalytic converter having a housing connected to the first duct and the second duct, and a catalyst device received in the housing.

11. The after-treating apparatus of exhaust gas according to claim 10, wherein the catalyst device comprises:
a honeycomb;
a supporter coated on the honeycomb, the supporter consisting of a mixture of γ-Al₂O₃ and Cr₂O₃; and
a catalyst supported on the supporter, the catalyst containing platinum and nickel with at least one promoter metal selected from Sn, Fe, Mn, Cu, V, Zn, Ba, Ag, and Au.
